(19) United States
(12) Patent Application Publication
(10) Pub. No.: US 2012/0108426 A1
(43) Pub. Date: May 3, 2012

(54) Saline water acidification treatment method

(75) Inventors: Terry Gong, Moraga, CA (US); Marcus G. Theodore, Salt Lake City, UT (US)

(73) Assignee: Earth Renaissance Technologies, LLC, Salt Lake City, UT (US)

(21) Appl. No.: 12/925,911

(22) Filed: Nov. 2, 2010

(51) Int. Cl. A01N 59/00; C02F 1/68

(52) U.S. Cl. 504/119; 210/749

(57) ABSTRACT

A method for acidifying saline waters for raising plants, comprising injecting sulfur dioxide to form a sufficient amount of sulfurous acid treated saline waters until these buffered acidified waters condition the surface membranes of plant roots to selectively take in water and ions needed for metabolism, while filtering others out to enable the plant to withstand and live in a high salt aqueous environment.

### BACKGROUND OF THE INVENTION

1. Field

This invention relates to water treatment methods. More particularly, it relates to a saline water acidification treatment method utilizing sulfur dioxide to create a sufficient amount of sulfurous acid to enhance a plant's ability to grow in saline water.

2. Objectives

The demand for water has driven human civilization to seek maximum efficiency from existing water supplies and to develop new alternative sources. Because agriculture uses the majority of all fresh water supplies, finding and developing sustainable substitutes for irrigation water for crop production will greatly improve human civilization and preserve sensitive ecosystems worldwide. Eleven of the thirteen mineral nutrients needed by plants are known to be present in adequate amounts in seawater. While the most abundance source of water on earth is seawater, its high salt and alkalinity content has always been problematic and kept us from being able to tap this natural source of nutrients and use it as a source for irrigation. This invention pertains to the use of a specific conditioning method to transform seawater, retentate brines derived from reverse osmosis filtration systems, and other forms of alkaline/saline waters from oil drilling and mining operations, etc. so that they can be used as a primary source of irrigation water; a concentrated medium to blend with and improve other overly-concentrated alkaline and saline water supplies for the propagation of agricultural crops for food, fuel, fodder, fiber, landscaping, bio-fuels, and other products.

3. State of the Art

Saline water is plentiful, but its re-use for raising plants is limited or its cleanup expensive. Plants prefer certain balanced water conditions including pH; see Extension Service West Virginia University “Horticulture; John W. Jett, Horticulture Specialist. Saline waters materially alter these balanced water conditions, resulting in plant stress. To accommodate salt stress, plants have developed certain defenses; see Wikepedia, Abscisic acid (ABA)http://users.ren.com/jkimball.ma.ultranet/Biology/Pages/A/ABA.html:
“Unlike animals, plants cannot flee from potentially harmful conditions like
Drought
Freezing
Exposure to salt water or salinated soil.
They must adapt or die.
The plant hormone abscisic acid (ABA) is the major player in mediating the adaptation of the plant to stress.
Here are a few examples.

1. Closing of Stomata
Some 90% of the water taken up by a plant is lost in transpiration. Most of this leaves the plant through the pores—called stomata—in the leaf. Each stoma is flanked by a pair of guard cells. When the guard cells are turgid, the stoma is open. When turgor is lost, the stoma closes.
ABA is the hormone that triggers closing of the stomata when soil water is insufficient to keep up with transpiration.
The mechanism:
ABA binds to receptors in the guard cells.
Receptor activation produces
a rise in pH in the cytosol;
transfer of Ca²⁺ from the vacuole and endoplasmic reticulum to the cytosol.
These changes cause ion channels in the plasma membrane to open allowing the release of ions (Cl⁻, organic [e.g., malate²⁻], and K⁺) from the cell.
The loss of these solutes from the cytosol reduces the osmotic pressure of the cell and thus turgor.
The stomata close.

2. Protecting Cells from Dehydration
ABA signaling turns on the expression of genes encoding proteins that protect cells—in seeds as well as in vegetative tissues—from damage when they become dehydrated.

3. Root Growth
ABA can stimulate root growth in plants that need to increase their ability to extract water from the soil.”

ABA levels inhibit low pH-induced elongation as part of some metabolic process; see “Inhibition of Low pH-induced Elongation in Avena Coleoptiles by Abscisic Acid” by Marilyn M. Rehm, et. al, Plant Physol. (1973) 946-948. A suggested explanation of the interrelationship between pH, abscisic acid and Ca⁺² is found in “pH, abscisic acid and the integration of metabolism in plants under stressed and non-stressed conditions: cellular responses to stress and their implication for plant water relations” by A.G. Netting, Oxford Journals Life Sciences, Journal of Experimental Botany; Volume 51, Issue 353, pp 147-158.

Acid pH is a highly variable environmental factor for root and plant cells that can modify apoplastic pH for nutrient acquisition. Plant pH recognition involves intracellular Ca⁺², which affects gene expression involving auxin; see Abstract, “Changes in external pH rapidly alter plant gene expression and modulate auxin and elicitor responses” by Ida Lager et al, 22 Apr. 2010, Plant, Cell & Environment, Volume 33, issue 9, pages 1513-1528. Acid-induced growth in root elongation is related to auxin-induced growth; see “Comparison of Auxin-induced and Acid-Induced Elongation in Soybean Hypocotyls” by Larry N. Vanderhoef et al, Plant Physiol. (1977) 59, 1004-1007. The hypothesis is that H+ ions act as a second messenger for auxin-promoted elongation.

Calcium influx, and the effects of Abscisic acid and Ca⁺² on stomatal aperture, and its role in promoting closure or in inhibiting opening were discussed in “Calcium influx at the plasmalemma of isolated guard cells of Commelina communis Effects of abscisic acid by E.A.C. MacRobbie, Planta (1989) 178: 231-241.

Rather than assist plants in optimizing their natural mechanisms to adapt to saline conditions, present attempts to improve and utilize seawater and other saline waters as a source of irrigation water use reverse osmosis and other methods to remove salts, generating retentate brines; see Laraway et al., U.S. Pat. No. 7,520,993 issued Apr. 21, 2009; Bader, U.S. Pat. No. 7,789,159 issued Sep. 7, 2010) for reuse use precipitation, filtration, and removing of dissolved salts. The expense of reverse osmosis and these other methods for agricultural use generally makes it cost prohibitive.

Still others use dilution by combining it with waters containing less salt. Others import and inject sulfuric acid directly into saline waters to adjust the pH and reduce its alkalinity prior to use. “Water Considerations for Container Production of Plants” by Doug Bailey, et al, HIL#557, NC State University, Horticulture Information Leaflets; http://www.ces.ncsu.edu/depts/hort/hil/hil-557.html, page 5. This strong acid does not effectively buffer the saline water at a set pH, resulting in wide pH fluctuations when applied to land detrimental to plant growth.

Current focus is on using saline waters to only grow halophytes and/or genetically modified salt tolerant plants (Gaxiola et al., U.S. Pat. No. 7,534,933 issued May 19, 2009); and/or seawater aquaculture These present efforts are outlined in the article “Saline Agriculture Salt-Tolerant Plants for Developing Countries” Report of a Panel of the Board on Science and Technology for International Development Office of International Affairs National Research Council; National Academy Press, Washington, D.C. 1990, Introduction; http://www.nap.edu/catalog/1489.html:
“ . . . . Salt-tolerant plants can utilize land and water unsuitable for salt-sensitive crops (glycophytes) for the economic production of food, fodder, fuel, and other products. Halophytes (plants that grow in soils or waters containing significant amounts of inorganic salts) can harness saline resources that are generally neglected and are usually considered impediments rather than opportunities for development.
Salts occur naturally in all soils. Rain dissolves these salts, which are then swept through streams and rivers to the sea. Where rainfall is sparse or there is no quick route to the sea, some of this water evaporates and the dissolved salts become more concentrated. In arid areas, this can result in the formation of salt lakes or in brackish groundwater, salinized soil, or salt deposits.
There are three possible domains for the use of salt-tolerant plants in developing countries. These are:
1. Farmlands salinized by poor irrigation practices;
2. Arid areas that overlie reservoirs of brackish water; and
3. Coastal deserts.
In some developing regions, there are millions of hectares of salinized farmland resulting from poor irrigation practices. These lands would require large (and generally unavailable) amounts of water to leach away the salts before conventional crops could be grown. However, there may be useful salt-tolerant plants that can be grown on them without this intervention. Although the introduction of salt-tolerant plants will not necessarily restore the soil to the point that conventional crops can be grown, soil character is often improved and erosion reduced.
Moreover, many arid areas overlie saline aquifers groundwater containing salt levels too high for the irrigation of conventional, salt-sensitive crops. Many of these barren lands can become productive by growing selected salt-tolerant crops and employing special cultural techniques using this store of brackish water for irrigation.
Throughout the developing world, there are extensive coastal deserts where seawater is the only water available. Although growing crops in sand and salty water is not a benign prospect for most farmers, for saline agriculture they can complement each other. The disadvantages of sand for conventional crops become advantages when saline water and salt-tolerant plants are used.
Sand is inherently low in the nutrients required for plant growth, has a high rate of water infiltration, and has low water-holding capacity. Therefore, agriculture on sand requires both irrigation and fertilizer. Surprisingly, 11 of the 13 mineral nutrients needed by plants are present in seawater in adequate concentrations for growing crops. In addition, the rapid infiltration of water through sand reduces salt buildup in the root zone when seawater is used for irrigation. The high aeration quality of sand is also valuable. This characteristic allows oxygen to reach the plant roots and facilitates growth. Although careful application of seawater and supplementary nutrients are necessary, the combination of sand, saltwater, sun, and salt-tolerant plants presents a valuable opportunity for many developing countries.
Of these three possibilities for the introduction of salt-tolerant plants (salinized farmland, undeveloped barren land, and coastal deserts); the reclamation of degraded farmland has several advantages: people, equipment, buildings, roads, and services are usually present and a social structure and market system already exist. The potential use of saline aquifers beneath barren lands depends on both the concentration and nature of the salts. The direct use of seawater for agriculture is probably the most challenging potential application.
Most contemporary crops have been developed through the domestication of plants from nonsaline environments. This is unfortunate since most of the earth's water resources are too salty to grow them. From experience in irrigated agriculture, Miyamoto (personal communication) suggests the following classification of potential crop damage from increasing salt levels:

| Irrigation Water Problems | Salts, ppm | Crop |
|---|---|---|
| Fresh | <125 | None |
| Slightly saline | 125-250 | Rare |
| Moderately saline | 250-500 | Occasional |
| Saline | 500-2,500 | Common |
| Highly saline | 2,500-5,000 | Severe |

Colorado River water, used for irrigation in the western United States, contains about 850 ppm of salts; seawater typically contains 32,000-36,000 ppm of salts. Salinity levels are usually expressed in terms of the electrical conductivity (EC) of the irrigation water or an aqueous extract of the soil; the higher the salt level, the greater the conductivity. The salinity of some typical water sources is shown in Table 1.

TABLE 1
Water Salinity.

| Irrigation | | | | | | |
|---|---|---|---|---|---|---|
| Water | | | | | | |
| Quality | | | | | | |
| Salinity | | | Colorado | Alamo | Negev | Pacific |
| Measurement | (Good) | (Marginal) | River | River | Groundwater | Ocean |
| Electrical | 0-1 | 1-3 | 1.3 | 4.0 | 4.0-7.0 | 46 |
| conductivity | | | | | | |
| (dS/m)* | | | | | | |
| Dissolved | 0-500 | 500-1,500 | 850 | 3,000 | 3,000-4,500 | 35,000 |
| solids, ppm | | | | | | |

*1 dS/m = 1 mmho/cm = (approx.) 0.06% NaCl = (approx.) 0.01 mole/l NaCl. 10,000 ppm = 10

o/oo (parts per thousand)=10 grams per liter=1.0%
In the International System of Units (SI), the unit of conductivity is the Siemens symbol, S, per meter. The equivalent unit commonly appearing in the literature is the mho (reciprocal ohm); 1 mho equals 1 Siemen.
SOURCE: Adapted from Epstein, 1983; Pasternak and De Malach, 1987; and Rhoades et al., 1988.
There are three broad approaches to utilizing saline water, depending on the salt levels present. These include the use of marginal to poor irrigation water with electrical conductivities (ECs) up to about 4 dS/m, the use of saline groundwaters such as those in Israel's Negev Desert with ECs up to about 8 dS/m, and the use of even more saline waters with salt concentrations up to that of seawater.
At low, but potentially damaging, salt levels, Rhoades and coworkers (1988) have grown commercial crops without the yield losses that would normally be anticipated. Through knowledge of crop sensitivity to salt at various growth stages, they used combinations of Colorado River water and Alamo River water to minimize the use of the higher quality water. For example, wheat seedlings were established with Colorado River water; Alamo River water was then used for irrigation through harvest with no loss in yield.
At higher salt levels, Pasternak and coworkers (1985) have developed approaches that involve special breeding and selection of crops and meticulous water control. The agriculture of Negev settlements in Israel is based on the production of cotton with higher yields, quality tomatoes for the canning industry, and quality melons for export—all grown with EC 4-7 dS/m groundwater. Experimental yields of a wide variety of traditional crops grown in Israel with water with ECs up to 15 dS/m, are shown in Table 6 (p. 35). In west Texas (USA), Miyamoto and coworkers (1984) report commercial production of alfalfa, melons, and tomatoes with EC 3-5 dS/m irrigation water, and cotton with 8 dS/m irrigation water.
The use of water with still higher salt levels up to, including, and even exceeding that of seawater for irrigation of various food, fuel, and fodder crops has been reported by many researchers including Aronson (1985; 1989), Boyko (1966), Epstein (1983; 1985), Gallagher (1985), Glenn and O'Leary (1985), Iyengar (1982), Pasternak (1987), Somers (1975), Yensen (1988), and others. These scientists have produced grains and oilseeds; grass, tree, and shrub fodder; tree and shrub fuel wood; and a variety of fiber, pharmaceutical, and other products using highly saline water.
Thus, depending on the soil or water salinity levels, salt-tolerant plants can be identified that will perform well in many environments in developing countries. The salt tolerance of some of these plants enables them to produce yields under saline conditions that are comparable to those obtained from salt-sensitive crops grown under nonsaline conditions.
The maximum amount and kind of salt that can be tolerated by halophytes and other salt-tolerant plants varies among species and even varieties of species. Many halophytes have a special and distinguishing feature—their growth is improved by low levels of salt. Other salt-tolerant plants grow well at low salt levels but beyond a certain level growth is reduced. With salt-sensitive plants, each increment of salt decreases their yield . . . .
Such data provide only relative guidelines for predicting yields of crops grown under saline conditions. Absolute yields are subject to numerous agricultural and environmental effects. Interactions between salinity and various soil, water, and climatic conditions all affect the plant's ability to tolerate salt. Some halophytes require fresh water for germination and early growth but can tolerate higher salt levels during later vegetative and reproductive stages. Some can germinate at high salinities but require lower salinity for maximal growth.
Traditional farming efforts usually focus on modifying the environment to suit the crop. In saline agriculture, an alternative is to allow the environment to select the crops, to match salt-tolerant plants with desirable characteristics to the available saline resources.
In many developing countries extensive areas of degraded and arid land are publicly owned and readily accessible for government-sponsored projects. These lands are often located in areas of high nutritional and economic need as well. If saline water is available, the introduction of salt-tolerant plants in these regions can improve food or fuel supplies, increase employment, help stem desertification, and contribute to soil reclamation.

### LIMITATIONS

Undomesticated salt-tolerant plants usually have poor agronomic qualities such as wide variations in germination and maturation. Salt-tolerant grasses and grains are subject to seed shattering and lodging. The foliage of salt-tolerant plants may not be suitable for fodder because of its high salt content. Nutritional characteristics or even potential toxicities have not been established for many edible salt-tolerant plants. When saline irrigation water is used for crop production, careful control is necessary to avoid salt buildup in the soil and to prevent possible contamination of freshwater aquifers.
Most importantly, salt-tolerant plants should not be cultivated as a substitute for good agricultural practice nor should they be used as a palliative for improper irrigation. They should be introduced only when and where conventional crops cannot be grown. Also, currently productive coastal areas (such as mangrove forests) should be managed and restored, not converted to other uses.
All of these limitations are impediments to the use of conventional methods for culture and harvest of salt-tolerant plants and the estimation of their production economics.”

The present methods to raise crops with saline water crop, thus involve salt removal using energy intensive methods (reverse osmosis), or limit the types of crops, which can be grown with saline waters. There thus remains a need for an inexpensive treatment method to condition saline wastewaters for growing a wider variety of crops. The method described below provides such an invention.

### SUMMARY OF THE INVENTION

The invention comprises acidifying saline waters by dosing with sulfur dioxide to create a sufficient amount of sulfurous acid to enhance a plant's natural stress defenses to allow growth in saline waters. Plants favor certain pH ranges, which are thrown out of balance under saline water conditions. It has been found that by adjusting the pH of saline waters to levels favoring plant growth, it is possible to influence the biological membranes that separates the interior of a plant's root from the outside environment—the plasmalemma. The addition of acid affects certain hormonal responses to assist the plant in adapting to saline stress by conserving water by minimizing transpiration water loss.

The method comprising acidifying saline waters by injecting sulfur dioxide to create a sufficient amount of sulfurous acid in the saline waters to provide buffered acidified waters, which condition the surface membranes of plant roots to selectively take in water and ions needed for metabolism, while filtering others out to enable the plant to withstand and live in a high salt aqueous environment by one or more of the following mechanisms:

adding sufficient sulfur dioxide, bisulfites and sulfites to obstruct chloride ions from entering plant roots;

adding sufficient sulfur dioxide, bisulfites, and sulfites to buffer the pH level to maintain optimal acidity conditions;

adding sufficient acid to modify apoplastic pH for nutrient acquisition and growth by producing auxin-induced growth;

enhancing abscisic acid stomatal closure, decreasing leaf transpiration to prevent water loss; and

balancing osmotic pressures.

This method thus enhances the natural plant mechanisms to overcome saline stress discussed above.

Where beneficial, calcium ions are added usually through lime addition to adjust and off-set high saline sodium and magnesium concentrations; thereby adjusting the sodium absorption ratios to that preferred by a given crop. The SAR is a calculated value that indicates the relative concentration of sodium to that of calcium and magnesium in water. Irrigation with waters having an SAR above 4 can result in root absorption of toxic levels of sodium, but this problem can be prevented by the addition of calcium. Calcium ions increase calcium ion influx into a plant's cytoplasm, rather than sodium ions to affect stomatal aperture closure to minimize plant water loss through leaf transpiration to aid a plant in conserving water.

In addition, abscisic acid may be further added to increase root exudation to increase permeability to water. Once the required pH is achieved to assist the plant adapting to saline stress conditions, the buffering effect of the bisulfite ion maintains the pH to prevent wide pH fluctuations encountered when conditioned waters are applied to land containing salts; thereby avoiding additional plant stress.

The exact manner in which sulfurous acid affects auxin levels and other growth substances and morphogens (often called phytohormones or plant hormones) is complex and employs the main mechanisms discussed. Acids also are involved in cell membrane homeostasis, tension regulation, area regulation, mechanosensitive membrane traffic used to describe membrane-reservoir exchange involved in membrane mechanics, osmosis and cellular osmotic response. Thus the selective application of sulfur dioxide and sulfurous acid to saline waters at a buffered pH favored by plants for growth, results in a balanced saline waters conducive to plant growth.

Though it is not usually listed as an essential micronutrient, chlorine (as chloride) is needed in small quantities by plants. However, in excess, greater than 2 meq/L, chloride can become a production problem. The principal effect of too much chloride (Cl⁻) is an increase in the osmotic pressure of the substrate solution that can reduce the availability of water to plants; “Water Considerations for Container Production of Plants” by Doug Bailey, et al, HIL#557, NC State University, Horticulture Information Leaflets; http://www.ces.ncsu.edu/depts/hort/hil/hil-557.html. Most salt-tolerant plants have evolved the ability to exclude sodium from their cells or compartmentalize it in vacuoles, but chloride is a different matter. Plant roots readily absorb chloride. Although the amount of chloride required by plants for photosynthesis is extremely small, high rates of chloride have notably negative effects by inhibiting the conversion of nitrate to ammonia, enhancing manganese availability, and increasing beneficial microorganisms. As a single charged anion, chloride is selectively displaced at the roots by double charged sulfate/sulfite anions.

Regardless if the system is hydroponics, soil, or artificial media system, by merely controlling the pH of the propagating system with sulfur dioxide, and sulfurous acid, it is possible to regulate the aperture openings of the plasmalemma to uptake nutrient ions when they are needed, and to keep harmful ions outside of the plant. Further, the acid addition enhances abscisic acid stomatal closure to conserve water. So, while this method does nothing to physically remove the high salt content in saline waters, the pH adjustment using a buffering acid interfering with chloride absorption provides an inexpensive method to raise crops with treated saline waters.

The advantages of the invention are that:

A. It does not require the use of reverse osmosis filtration to filter and remove salts from seawater prior to using it.

B. It does not require dilution with less saline water prior to using it.

C. The process mimics the natural acidification process by oxidizing elemental sulfur into sulfur dioxide (S0₂), and dosing it into saline oil production waters or seawater or the brine retentate from reverse osmosis filtration systems. It causes the molecular bonds of these saline waters to sequentially release hydrogen to form an aqueous solution within itself; unlike sulfuric acid, which acidifies by the importation and addition of acid into the system.

D. This method provides and uses additional acidity to physically change and alter saline waters to serve as mediums to control the pH of the soil, artificial media, or hydroponics solutions;

E. This method uses acidity and pH control to regulate and influence the physiology of plants and their uptake of nutrients, in order to withstand the higher salt content associated with these waters;

F. This method specifically incorporates the use of supplemental calcium whenever saline waters are land applied to off-set sodium and adjust the sodium absorption ratio (SAR) and where ever calcium deficient; see Water Considerations for Container Production of Plants Sodium, by Doug Bailey, supra. Sodium is an essential element for some plants such as celery and spinach, but most greenhouse and nursery crops have minimal sodium requirements.

One example for use of the method is to condition saline production waters from various coal and oil projects, which contain high selenium, and arsenic levels, and high electrical conductivity via acidification/alkalinization, which first removes bicarbonates in these saline waters to reduce electrical conductivity with acid addition. If disinfection is also required, the pH and dwell time are adjusted for a 1 hour or less dwell time at a pH less than 3.5. Next, electrical conductivity is further reduced by removing some selenium and arsenic, along with heavy metal hydroxides and excess calcium sulfates and phosphates, which precipitate when lime or alum is added to remove metal hydroxides and pH balance the saline treated waters for land application. Selenium and arsenic are removed with pH elevation and iron III addition to precipitate out the selenium and arsenic along with the iron hydroxides for removal by filtration.

Thus, the saline waters may be adjusted to that required for land application for raising plants. If the contaminants are too concentrated, some dilution may first be required.

The present invention may be embodied in other specific forms without departing from its methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

We claim:

1. A method for acidifying saline waters for raising plants, comprising:
a. injecting sulfur dioxide into saline waters to form sulfurous acid until sufficient buffered acidified saline waters condition the surface membranes of plant roots to selectively take in water and ions needed for metabolism, while filtering others out to enable the plant to withstand and live in a high salt aqueous environment by one or more of the following mechanisms:
i. adding sufficient bisulfite and sulfite to obstruct chloride ions from entering plant roots;
ii. adding sufficient bisulfites and sulfites to buffer the pH level to maintain optimal acidity conditions;
iii. adding sufficient bisulfites and sulfites to modify apoplastic pH for nutrient acquisition and growth by producing auxin-induced growth;
iii. adding sufficient bisulfites and sulfites to enhance abscisic acid stomatal closure, decreasing leaf transpiration to prevent water loss; and
iv. adding sufficient bisulfites and sulfites to balance osmotic pressures to maintain turgidity.

2. A method for acidifying saline waters for raising plants according to claim 1, including adding calcium ions to increase calcium ion influx into a plant's cytoplasm, rather than sodium ions to affect stomatal aperture closure to minimize plant water loss through leaf transpiration to aid a plant in conserving water.

3. A method of acidifying saline waters for raising plants according to claim 2, including the addition of abscisic acid and growth substances.
